(19) United States
(12) Patent Application Publication
(10) Pub. No.: US 2025/0089768 A1
(43) Pub. Date: Mar. 20, 2025

(54) AEROSOL GENERATING DEVICE INCLUDING THERMAL INSULATOR

(71) Applicant: KT&G CORPORATION, Daejeon (KR)

(72) Inventors: Dong Sung KIM, Seoul (KR); Yong Hwan KIM, Anyang-si (KR); Youngbum KWON, Yongin-si (KR); Hunil LIM, Seoul (KR)

(73) Assignee: KT&G CORPORATION, Daejeon (KR)

(21) Appl. No.: 18/569,428

(22) PCT Filed: Jul. 10, 2023
(86) PCT No.: PCT/KR2023/009717

§ 371 Date: Dec. 12, 2023

(30) Foreign Application Priority Data
Aug. 10, 2022 (KR) 10-2022-0099713
Oct. 7, 2022 (KR) 10-2022-0128335

(51) Int. Cl. A24F 40/40; A24F 40/20; A24F 40/51; A24F 40/53; F16J 15/10

(52) U.S. Cl. CPC A24F 40/40; A24F 40/20; A24F 40/51; A24F 40/53; F16J 15/104

(57) ABSTRACT

An aerosol generating device includes a heater, a printed circuit board (PCB), an electrical line configured to connect the heater and the PCB, and a thermal insulator. The thermal insulator includes a thermally insulating housing, a flange protruding from a second surface of the thermally insulating housing, a passage through which the electrical line passes, wherein the passage is defined in the flange, a first seal surrounding the flange, and a second seal overlapping the first seal and the electrical line.

### TECHNICAL FIELD

The disclosure relates to an aerosol generating device, for example, to an aerosol generating device including a thermal insulator.

### BACKGROUND ART

Techniques for introducing airflows into an aerosol generating article are being developed to provide atomization performance. For example, aerosol generating devices that generate an aerosol from an aerosol generating article in a non-burning manner are being developed. The above description is information the inventor(s) acquired during the course of conceiving the present disclosure, or already possessed at the time, and is not necessarily art publicly known before the present application was filed.

### DISCLOSURE OF INVENTION

### Technical Problem

One aspect of the disclosure may provide a thermal insulator for maintaining a degree of thermal insulation and an aerosol generating device including the same.

### Solution to Problem

According to an embodiment, an aerosol generating device includes a heater, a printed circuit board (PCB), an electrical line configured to connect the heater and the PCB, and a thermal insulator. The thermal insulator may include a thermally insulating housing including a first surface, a second surface opposite to the first surface, and a side surface between the first surface and the second surface to surround the heater, a flange protruding from the second surface, a passage through which the electrical line passes, wherein the passage may be defined in the flange, a first seal surrounding the flange, and a second seal overlapping the first seal and the electrical line.

In an embodiment, the first seal may include an outer enclosure disposed on an outer side of the flange, an inner enclosure disposed on an inner side of the flange and in the passage, and a connecting enclosure connecting the outer enclosure and the inner enclosure.

In an embodiment, the first seal may include a first base disposed on the second surface, and a second base disposed on the first base. A width of the first base may be greater than a width of the second base in a direction away from the flange.

In an embodiment, the second seal may include a groove configured to receive the electrical line at least partially.

In an embodiment, the first seal may include an opening through which the electrical line passes. The second seal may be disposed at least partially in the opening.

In an embodiment, the first seal and the second seal may be separable from each other.

In an embodiment, the first seal and the second seal may each include an elastic material.

In an embodiment, the flange may protrude from the second surface in a direction from the first surface toward the second surface.

In an embodiment, the aerosol generating device may include a temperature sensor configured to detect a temperature of the heater. The aerosol generating device may include an additional electrical line configured to connect the temperature sensor and the PCB.

In an embodiment, the aerosol generating device may include an insertion detection sensor configured to detect an aerosol generating article. The aerosol generating device may include an additional electrical line configured to connect the insertion detection sensor and the PCB.

According to an embodiment, a thermal insulator includes a thermally insulating housing including a first surface, a second surface opposite to the first surface, and a side surface between the first surface and the second surface, a flange protruding from the second surface, a passage defined in the flange, a first seal surrounding the flange, and a second seal overlapping the first seal.

In an embodiment, the first seal may include an outer enclosure disposed on an outer side of the flange, an inner enclosure disposed on an inner side of the flange and in the passage, and a connecting enclosure connecting the outer enclosure and the inner enclosure.

In an embodiment, the first seal may include a first base disposed on the second surface, and a second base disposed on the first base. A width of the first base may be greater than a width of the second base in a direction away from the flange.

In an embodiment, the second seal may include a groove.

In an embodiment, the first seal may include an opening. The second seal may be disposed at least partially in the opening.

### Advantageous Effects of Invention

According to an embodiment, electrical lines may pass through a thermal insulator. According to an embodiment, the degree of thermal insulation may be maintained through a thermal insulator. The effects of the aerosol generating device including the thermal insulator according to an embodiment may not be limited to the above-mentioned effects, and other unmentioned effects may be clearly understood from the following description by one of ordinary skill in the art.

### BRIEF DESCRIPTION OF DRAWINGS

FIG. 1 is a diagram illustrating an aerosol generating device according to an embodiment.

FIG. 2 is a diagram illustrating an aerosol generating device according to an embodiment.

FIG. 3 is a diagram illustrating an aerosol generating device according to an embodiment.

FIG. 4 is a diagram illustrating an aerosol generating article according to an embodiment.

FIG. 5 is a diagram illustrating an aerosol generating article according to an embodiment.

FIG. 6 is a block diagram of an aerosol generating device according to an embodiment.

FIG. 7 is a perspective view of an aerosol generating device according to an embodiment.

FIG. 8 is a perspective view of an aerosol generating device including a thermal insulator and a printed circuit board (PCB) according to an embodiment.

FIG. 9 is an exploded perspective view of a thermal insulator according to an embodiment.

FIG. 10 is a front view of a thermal insulator according to an embodiment.

FIG. 11 is a cross-sectional view of the thermal insulator of FIG. 10, taken along a line 11-11, according to an embodiment.

FIG. 12 is an enlarged view of a portion A of the thermal insulator of FIG. 11 according to an embodiment.

FIG. 13 is a perspective view of a first seal according to an embodiment.

FIG. 14 is a front view of a first seal according to an embodiment.

FIG. 15 is a plan view of a first seal according to an embodiment.

FIG. 16 is a side view of a first seal according to an embodiment.

FIG. 17 is a rear view of a first seal according to an embodiment.

FIG. 18 is a perspective view of a second seal according to an embodiment.

FIG. 19 is a front view of a second seal according to an embodiment.

FIG. 20 is a plan view of a second seal according to an embodiment.

FIG. 21 is a side view of a second seal according to an embodiment.

FIG. 22 is a rear view of a second seal according to an embodiment.

### MODE FOR THE INVENTION

The terms used in the embodiments are selected from among common terms that are currently widely used, in consideration of their function in the embodiments of the present disclosure. However, the terms may become different according to an intention of one of ordinary skill in the art, a precedent, of the advent of new technology. In particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Terms such as “unit,” “module,” etc., as used in the specification may refer to a part for processing at least one function or operation and which may be implemented as hardware, software, or a combination of hardware and software.

Hereinbelow, embodiments of the disclosure will be described in detail with reference to the accompanying drawings so that the embodiments may be readily implemented by one of ordinary skill in the technical field to which the disclosure pertains. However, embodiments may be implemented in many different forms, and the present disclosure is not limited to the embodiments described herein.

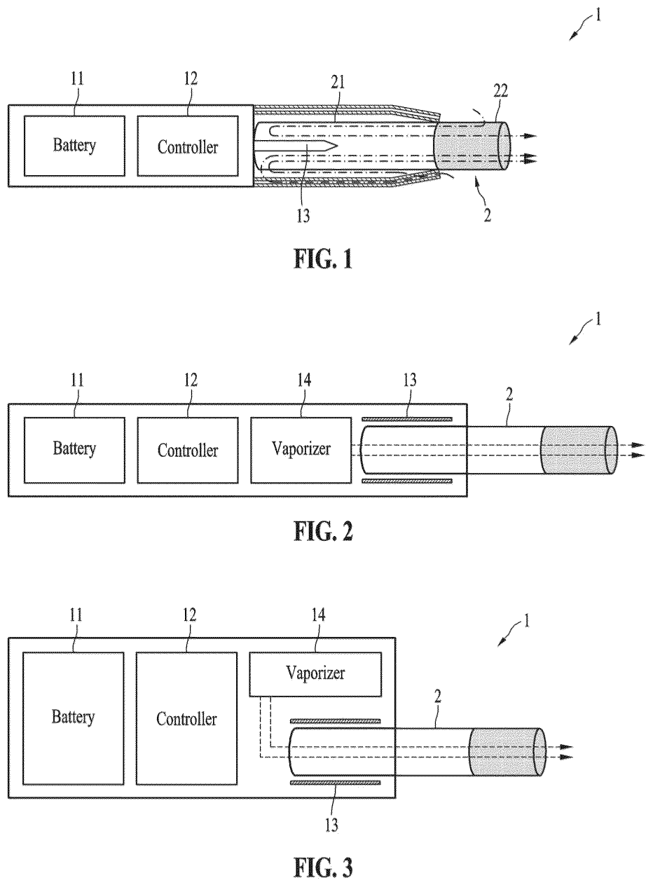

FIG. 1 is a diagram illustrating an aerosol generating device according to an embodiment. FIG. 2 is a diagram illustrating the aerosol generating device according to an embodiment. FIG. 3 is a diagram illustrating the aerosol generating device according to an embodiment.

Referring to FIG. 1, an aerosol generating device 1 may include a battery 11, a controller 12, and a heater 13. Referring to FIGS. 2 and 3, the aerosol generating device 1 may further include a vaporizer 14. An aerosol generating article 2 may be inserted into an inner space of the aerosol generating device 1.

The aerosol generating device 1 shown in FIGS. 1 to 3 may include components related to an embodiment described herein. Therefore, it is to be understood by one of ordinary skill in the art to which the disclosure pertains that the aerosol generating device 1 may further include other general-purpose components in addition to the ones shown in FIGS. 1 to 3.

Although it is shown that the heater 13 is included in the aerosol generating device 1 in FIGS. 2 and 3, the heater 13 may be omitted as needed.

FIG. 1 illustrates a linear alignment of the battery 11, the controller 12, and the heater 13. FIG. 2 illustrates a linear alignment of the battery 11, the controller 12, the vaporizer 14, and the heater 13, FIG. 3 illustrates a parallel alignment of the vaporizer 14 and the heater 13. However, the internal structure of the aerosol generating device 1 is not limited to what is shown in FIGS. 1 to 3. That is, the alignments of the battery 11, the controller 12, the heater 13, and the vaporizer 14 may be changed depending on the design of the aerosol generating device 1.

When the aerosol generating article 2 is inserted into the aerosol generating device 1, the aerosol generating device 1 may operate the heater 13 and/or the vaporizer 14 to generate an aerosol. The aerosol generated by the heater 13 and/or the vaporizer 14 may pass through the aerosol generating article 2 into the user.

Even when the aerosol generating article 2 is not inserted in the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14, and may supply power required for the controller 12 to operate. The battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1, in addition to the battery 11, the heater 13, and the vaporizer 14. The controller 12 may verify a state of each of the components of the aerosol generating device 1 to determine whether the aerosol generating device 1 is in an operable state.

The controller 12 may include at least one processor. The at least one processor may be implemented as an array of a plurality of logic gates, or may be implemented as a combination of a general-purpose microprocessor and a memory in which a program executable by the microprocessor is stored. It is to be understood by those having ordinary skill in the art to which the disclosure pertains that the at least one processor may be implemented in other types of hardware.

The heater 13 may be heated by the power supplied by the battery 11. For example, when an aerosol generating article is inserted in the aerosol generating device 1, the heater 13 may be disposed outside the aerosol generating article. The heated heater 13 may thus raise the temperature of an aerosol generating material in the aerosol generating article.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the aerosol generating device 1 or may be set by the user.

The heater 13 may be an induction heater. Specifically, the heater 13 may include an electrically conductive coil for heating the aerosol generating article in an induction heating manner, and the aerosol generating article may include a susceptor to be heated by the induction heater.

For example, the heater 13 may include a tubular heating element, a plate-shaped heating element, a needle-shaped heating element, or a rod-shaped heating element, and may heat the inside or outside of the aerosol generating article 2 according to the shape of a heating element.

The heater 13 may be provided as a plurality of heaters in the aerosol generating device 1. In this case, the plurality of heaters 13 may be disposed to be inserted into the aerosol generating article 2 or may be disposed outside the aerosol generating article 2. Some of the plurality of heaters 13 may be disposed to be inserted into the aerosol generating article 2, and the rest may be disposed outside the aerosol generating article 2. The shape of the heater 13 is not limited to what is shown in FIGS. 1 through 3 but may be provided in various shapes.

The vaporizer 14 may heat a liquid composition to generate an aerosol, and the generated aerosol may pass through the aerosol generating article 2 into the user. That is, the aerosol generated by the vaporizer 14 may travel along an airflow path of the aerosol generating device 1, and the airflow path may be configured such that the aerosol generated by the vaporizer 14 may pass through the aerosol generating article into the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. For example, the liquid composition may be a liquid including a tobacco-containing material having a volatile tobacco flavor ingredient, or a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit flavor ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. Liquid compositions may include aerosol formers such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. The heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer. However, embodiments are not limited thereto.

Meanwhile, the aerosol generating device 1 may further include general-purpose components in addition to the battery 11, the controller 12, the heater 13, and the vaporizer 14. For example, the aerosol generating device 1 may include a display that outputs visual information and/or a motor that outputs tactile information. The aerosol generating device 1 may include at least one sensor (e.g., a puff sensor, a temperature sensor, an aerosol generating article insertion detection sensor, etc.). The aerosol generating device 1 may be manufactured to have a structure allowing external air to be introduced or internal gas to flow out even while the aerosol generating article 2 is inserted.

Although not shown in FIGS. 1 to 3, the aerosol generating device 1 may constitute a system along with a separate cradle. For example, the cradle may be used to charge the battery 11 of the aerosol generating device 1. The cradle may be used to heat the heater 13, with the cradle and the aerosol generating device 1 coupled.

The aerosol generating article 2 may be similar to a conventional combustible cigarette. For example, the aerosol generating article 2 may be divided into a first portion including an aerosol generating material and a second portion including a filter or the like. The second portion of the aerosol generating article 2 may also include the aerosol generating material. For example, the aerosol generating material provided in the form of granules or capsules may be inserted into the second portion.

The first portion may be entirely inserted into the aerosol generating device 1, and the second portion may be exposed outside. Only the first portion may be partially inserted into the aerosol generating device 1, or the first portion may be entirely into the aerosol generating device 1 and the second portion may be partially inserted into the aerosol generating device 1. The user may inhale the aerosol with the second portion in their mouth. In this case, the aerosol may be generated as external air passes through the first portion, and the generated aerosol may pass through the second portion into the mouth of the user.

For example, the external air may be introduced through at least one air path formed in the aerosol generating device 1. In this example, the opening or closing and/or the size of the air path formed in the aerosol generating device 1 may be adjusted by the user. Accordingly, an amount of atomization, a sense of smoking, or the like may be adjusted by the user. The external air may be introduced into the inside of the aerosol generating article 2 through at least one hole formed on a surface of the aerosol generating article 2.

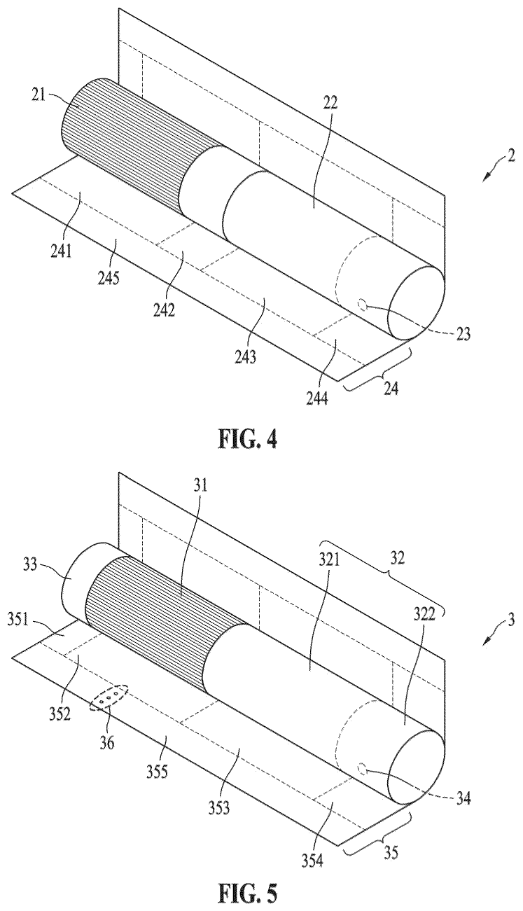

FIG. 4 is a diagram illustrating an aerosol generating article according to an embodiment.

Referring to FIG. 4, the aerosol generating article 2 may include a tobacco rod 21 and a filter rod 22. The first portion and the second portion described above with reference to FIGS. 1 to 3 may include the tobacco rod 21 and the filter rod 22, respectively.

Although the filter rod 22 is illustrated as having a single segment in FIG. 4, embodiments are not limited thereto. That is, alternatively, the filter rod 22 may include a plurality of segments. For example, the filter rod 22 may include a segment that cools an aerosol and a segment that filters a predetermined ingredient contained in an aerosol. The filter rod 22 may further include at least one segment that performs another function.

The diameter of the aerosol generating article 2 may be in a range of 5 mm to 9 mm, and the length thereof may be about 48 mm. However, embodiments are not limited thereto. For example, the length of the tobacco rod 21 may be about 12 mm, the length of a first segment of the filter rod 22 may be about 10 mm, the length of a second segment of the filter rod 22 may be about 14 mm, and the length of a third segment of the filter rod 22 may be about 12 mm. However, embodiments are not limited thereto.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more of wrappers 24 in an overlapping manner. For example, the tobacco rod 21 may be wrapped with a first wrapper 241, and the filter rod 22 may be wrapped with wrappers 242, 243, and 244. In addition, the aerosol generating article 2 may be entirely wrapped again with a single wrapper 245. For example, when the filter rod 22 includes a plurality of segments, the plurality of segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. The first wrapper 241 and the second wrapper 242 may be formed of oilproof paper and/or an aluminum laminated wrapping material.

The third wrapper 243 may be formed of hard wrapping paper. For example, the basis weight of the third wrapper 243 may be in a range of 88 g/m² to 96 g/m², and may be desirably in a range of 90 g/m²to 94 g/m². The thickness of the third wrapper 243 may be in a range of 120 μm to 130 μm, and may be desirably about 125 μm.

The fourth wrapper 244 may be formed of oilproof hard wrapping paper. For example, the basis weight of the fourth wrapper 244 may be in a range of 88 g/m² to 96 g/m², and may be desirably in a range of 90 g/m² to 94 g/m². The thickness of the fourth wrapper 244 may be in a range of 120 μm to 130 μm, and may be desirably about 125 μm.

The fifth wrapper 245 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 245 may be in a range of 57 g/m² to 63 g/m², and may be desirably 60 g/m². The thickness of the fifth wrapper 245 may be in a range of 64 μm to 70 μm, and may be desirably about 67 μm.

The fifth wrapper 245 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 245 without limitation.

The fifth wrapper 245 may prevent the aerosol generating article 2 from burning. For example, there may be a probability that the aerosol generating article 2 burns when the tobacco rod 21 is heated by the heater 13. Specifically, when the temperature rises above the ignition point of any one of the materials included in the tobacco rod 21, the aerosol generating article 2 may burn. Even in this case, it may still be possible to prevent the aerosol generating article 2 from burning because the fifth wrapper 245 includes a non-combustible material.

The fifth wrapper 245 may prevent the aerosol generating device 1 from being contaminated by substances produced in the aerosol generating article 2. Liquid substances may be produced in the aerosol generating article 2 when a user puffs. For example, as an aerosol generated in the aerosol generating article 2 is cooled by external air, such liquid substances (e.g., moisture, etc.) may be produced. As the aerosol generating article 2 is wrapped with the fifth wrapper 245, the liquid substances generated within the aerosol generating article 2 may be prevented from leaking out of the aerosol generating article 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may include other additives, such as, for example, a flavoring agent, a wetting agent, and/or an organic acid. The tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be formed as a sheet or a strand. The tobacco rod 21 may be formed with a cut tobacco filler from finely cut tobacco sheets. The tobacco rod 21 may be enveloped by a heat-conductive material. The thermally conductive material may be, for example, a metal foil such as aluminum foil. However, embodiments are not limited thereto. For example, the heat-conductive material enveloping the tobacco rod 21 may evenly distribute the heat transferred to the tobacco rod 21 to improve the thermal conductivity to be applied to the tobacco rod 21, thereby improving the taste of tobacco. The thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod, or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm. However, embodiments are not limited thereto.

A desirable length of the first segment may be adopted from a range of 4 mm to 30 mm. However, embodiments are not limited thereto. Desirably, the length of the first segment may be 10 mm. However, embodiments are not limited thereto.

The first segment may have a hardness that is adjustable through an adjustment of the content of a plasticizer in the process of manufacturing the first segment. The first segment may be manufactured by inserting a structure such as a film or a tube of the same or different materials therein (e.g., in the hollow).

The second segment of the filter rod 22 may cool an aerosol generated as the heater 13 heats the tobacco rod 21. The user may thus inhale the aerosol cooled down to a suitable temperature.

The length or diameter of the second segment may be determined in various ways according to the shape of the aerosol generating article 2. For example, a desirable length of the second segment may be adopted from a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to fiber formed of a polymer. The second segment may be manufactured by weaving a separate fiber to which a flavoring liquid is applied and the fiber formed of the polymer together. The second segment may be formed with a crimped polymer sheet.

The polymer may be prepared with a material selected from the group consisting of polyethylene (PE), polypropylene (PP), polyvinyl chloride (PVC), polyethylene terephthalate (PET), polylactic acid (PLA), cellulose acetate (CA) and aluminum foil.

As the second segment is formed with the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed with the crimped polymer sheet may be formed of a material having a thickness between about 5 μm and about 300 μm, for example, between about 10 μm and about 250 μm. The total surface area of the second segment may be between about 300 mm²/mm and about 1000 mm²/mm. An aerosol cooling element may be formed from a material having a specific surface area between about 10 mm²/mg and about 100 mm²/mg.

Meanwhile, the second segment may include a thread containing a volatile flavor ingredient. The volatile flavor ingredient may be menthol. However, embodiments are not limited thereto. For example, the thread may be filled with a sufficient amount of menthol to provide at least 1.5 mg of menthol to the second segment.

The third segment of the filter rod 22 may be a cellulose acetate filter. A desirable length of the third segment may be adopted from a range of 4 mm to 20 mm. For example, the length of the third segment may be about 12 mm. However, embodiments are not limited thereto.

The third segment may be manufactured such that a flavor is generated by spraying a flavoring liquid onto the third segment in the process of manufacturing the third segment. A separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the flavor carried to the user may last much longer.

The filter rod 22 may include at least one capsule 23. The capsule 23 may perform a function of generating a flavor, or a function of generating an aerosol. For example, the capsule 23 may have a structure in which a liquid containing a fragrance is wrapped with a film. The capsule 23 may have a spherical or cylindrical shape. However, embodiments are not limited thereto.

FIG. 5 is a diagram illustrating an aerosol generating article according to an embodiment.

Referring in FIG. 5, an aerosol generating article 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied in the tobacco rod 31 during smoking from flowing into an aerosol generating device (e.g., the aerosol generating device 1 of FIGS. 1 to 3).

The filter rod 32 may include a first segment 321 and a second segment 322. Here, the first segment 321 may correspond to the first segment of the filter rod 22 of FIG. 4, and the second segment 322 may correspond to the third segment of the filter rod 22 of FIG. 4.

The diameter and the total length of the aerosol generating article 3 may correspond to the diameter and the total length of the aerosol generating article 2 of FIG. 4. For example, the length of the front end plug 33 may be about 7 mm, the length of the tobacco rod 31 may be about 15 mm, the length of the first segment 321 may be about 12 mm, and the length of the second segment 322 may be about 14 mm. However, embodiments are not limited thereto.

The aerosol generating article 3 may be wrapped by at least one wrapper 35. The wrapper 35 may have at least one hole through which external air flows inside or internal gas flows outside. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the aerosol generating article 3 may be entirely wrapped again with a fifth wrapper 355.

At least one perforation 36 may be formed in the fifth wrapper 355. For example, the perforation 36 may be formed in an area surrounding the tobacco rod 31. However, embodiments are not limited thereto. The perforation 36 may perform a function of transferring heat generated by the heater 13 shown in FIGS. 2 and 3 to the inside of the tobacco rod 31.

The second segment 322 may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape. However, embodiments are not limited thereto.

The first wrapper 351 may be a combination of general filter wrapping paper and a metal foil such as aluminum foil. For example, the total thickness of the first wrapper 351 may be in a range of 45 μm to 55 μm, and may be desirably about 50.3 μm. The thickness of the metal foil of the first wrapper 351 may be in a range of 6 μm to 7 μm, and may be desirably 6.3 μm. The basis weight of the first wrapper 351 may be in a range of 50 g/m² to 55 g/m², and may be desirably 53 g/m².

The second wrapper 352 and the third wrapper 353 may be formed with general filter wrapping paper. For example, the second wrapper 352 and the third wrapper 353 may be porous wrapping paper or non-porous wrapping paper.

For example, the porosity of the second wrapper 352 may be 35000 CU. However, embodiments are not limited thereto, The thickness of the second wrapper 352 may be in a range of 70 μm to 80 μm, and may be desirably about 78 μm. The basis weight of the second wrapper 352 may be in a range of 20 g/m² to 25 g/m², and may be desirably 23.5 g/m².

For example, the porosity of the third wrapper 353 may be 24000 CU. However, embodiments are not limited thereto. The thickness of the third wrapper 353 may be in a range of 60 μm to 70 μm, and may be desirably about 68 μm. The basis weight of the third wrapper 353 may be in a range of 20 g/m² to 25 g/m², and may be desirably 21 g/m².

The fourth wrapper 354 may be formed with polylactic acid (PLA) laminated paper. Here, the PLA laminated paper may refer to three-ply paper including a paper layer, a PLA layer, and a paper layer. For example, the thickness of the fourth wrapper 354 may be in a range of 100 μm to 120 μm, and may be desirably about 110 μm. The basis weight of the fourth wrapper 354 may be in a range of 80 g/m² to 100 g/m², and may be desirably 88 g/m².

The fifth wrapper 355 may be formed of sterile paper (e.g., MFW). Here, the sterile paper (MFW) may refer to paper specially prepared such that it has enhanced tensile strength, water resistance, smoothness, or the like, compared to general paper. For example, the basis weight of the fifth wrapper 355 may be in a range of 57 g/m² to 63 g/m², and may be desirably about 60 g/m². The thickness of the fifth wrapper 355 may be in a range of 64 μm to 70 μm, and may be desirably about 67 μm.

The fifth wrapper 355 may have a predetermined material internally added thereto. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied to (or used to coat) the fifth wrapper 355 without limitation.

The front end plug 33 may be formed of cellulose acetate. For example, the front end plug 33 may be manufactured by adding a plasticizer (e.g., triacetin) to cellulose acetate tow. The mono denier of a filament of the cellulose acetate tow may be in a range of 1.0 to 10.0, and may be desirably in a range of 4.0 to 6.0. The mono denier of the filament of the front end plug 33 may be more desirably 5.0. A cross section of the filament constituting the front end plug 33 may be Y-shaped. The total denier of the front end plug 33 may be in a range of 20000 to 30000, and may be desirably in a range of 25000 to 30000. The total denier of the front end plug 33 may be more desirably 28000.

The front end plug 33 may include at least one channel. The cross-sectional shape of the channel may be manufactured in various manners.

The tobacco rod 31 may correspond to the tobacco rod 21 described above with reference to FIG. 4. Thus, a detailed description of the tobacco rod 31 will be omitted here.

The first segment 321 may be formed of cellulose acetate. For example, the first segment may be a tubular structure including a hollow therein. The first segment 321 may be manufactured by adding a plasticizer (e.g., triacetin) to cellulose acetate tow. For example, the mono denier and the total denier of the first segment 321 may be the same as the mono denier and the total denier of the front end plug 33.

The second segment 322 may be formed of cellulose acetate. The mono denier of a filament of the second segment 322 may be in a range of 1.0 to 10.0, and may be desirably in a range of 8.0 to 10.0. The mono denier of the filament of the second segment 322 may be more desirably 9.0. A cross section of the filament of the second segment 322 may be Y-shaped. The total denier of the second segment 322 may be in a range of 20000 to 30000, and may be desirably 25000.

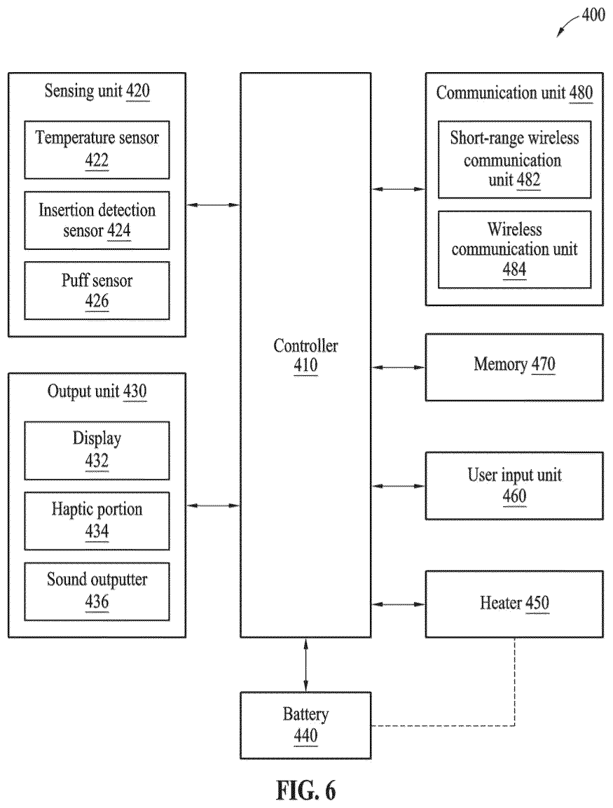

FIG. 6 is a block diagram of an aerosol generating device according to an embodiment.

Referring to FIG. 6, the aerosol generating device 400 may include a controller 410, a sensing unit 420, an output unit 430, a battery 440, a heater 450, a user input unit 460, a memory 470, and a communication unit 480. However, the internal structure of the aerosol generating device 400 is not limited to what is shown in FIG. 6. It is to be understood by one of ordinary skill in the art to which the disclosure pertains that some of the components shown in FIG. 6 may be omitted or new components may be added according to the design of the aerosol generating device 400.

The sensing unit 420 may sense a state of the aerosol generating device 400 or a state of an environment around the aerosol generating device 400, and transmit sensing information obtained through the sensing to the controller 410. Based on the sensing information, the controller 410 may control the aerosol generating device 400 to control operations of the heater 450, restrict smoking, determine whether an aerosol generating article (e.g., a cigarette, a cartridge, etc.) is inserted, display a notification, and perform other functions.

The sensing unit 420 may include at least one of a temperature sensor 422, an insertion detection sensor 424, or a puff sensor 426. However, embodiments are not limited thereto.

The temperature sensor 422 may sense a temperature at which the heater 450 for an aerosol generating material) is heated. The aerosol generating device 400 may include a separate temperature sensor for sensing the temperature of the heater 450, or the heater 450 itself may perform a function as a temperature sensor. The temperature sensor 422 may be arranged around the battery 440 to monitor the temperature of the battery 440.

The insertion detection sensor 424 may sense whether the aerosol generating article is inserted or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 426 may sense a puff from a user based on various physical changes in an airflow path or airflow channel. For example, the puff sensor 426 may sense the puff of the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS), a proximity sensor, or a red, green, blue (RGB) sensor (e.g., an illuminance sensor), in addition to the sensors 422 through 426 described above. A function of each sensor may be intuitively inferable from its name by one of ordinary skill in the art, and thus, a more detailed description thereof will be omitted here.

The output unit 430 may output information about the state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as an input device in addition to an output device.

The display 432 may visually provide information about the aerosol generating device 400 to the user. The information about the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display (LCD) panel, an organic light-emitting display (OLED) panel, or the like. The display 432 may be in the form of a light-emitting diode (LED) device.

The haptic portion 434 may provide information about the aerosol generating device 400 to the user in a haptic way by converting an electrical signal into a mechanical stimulus or an electrical stimulus. The haptic portion 434 may include, for example, a motor, a piezoelectric element, or an electrical stimulation device.

The sound outputter 436 may provide information about the aerosol generating device 400 to the user in an auditory way. For example, the sound outputter 436 may convert an electrical signal into a sound signal and externally output the sound signal.

The battery 440 may supply power to be used to operate the aerosol generating device 400. The battery 440 may supply power to heat the heater 450. The battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 6, the aerosol generating device 400 may further include a power conversion circuit (e.g., a direct current (DC)-to-DC (DC/DC) converter) that converts power of the battery 440 and supplies the power to the heater 450. When the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 6, the aerosol generating device 400 may further include a power conversion circuit, for example, a low dropout (LDO) circuit or a voltage regulator circuit, which converts power of the battery 440 and supplies the power to respective components.

In an embodiment, the heater 450 may be formed of any suitable electrically resistive material. The electrically resistive material may be, for example, a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto, The heater 450 may be implemented as a metal heating wire, a metal heating plate on which an electrically conductive track is arranged, a ceramic heating element, or the like. However, embodiments are not limited thereto.

In an embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating an aerosol generating article and a second heater for heating a liquid.

The user input unit 460 may receive information input from the user or may output information to the user. For example, the user input unit 460 may include a keypad, a dome switch, a touchpad (e.g. a contact capacitive type, a pressure resistive film type, an infrared sensing type, a surface ultrasonic conduction type, an integral tension measurement type, a piezo effect method, etc.), a jog wheel a jog switch, or the like. However, embodiments are not limited thereto. Although not shown in FIG. 6, the aerosol generating device 400 may further include a connection interface such as a universal serial bus (USB) interface, and may be connected to another external device through the connection interface such as a USB interface to transmit and receive information or to charge the battery 440.

The memory 470, which is hardware for storing various pieces of data processed in the aerosol generating device 400, may store data processed by the controller 410 and data to be processed thereby. The memory 470 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile, data associated with a smoking pattern of the user, or the like.

The communication unit 480 may include at least one component for communicating with another electronic device. For example, the communication unit 480 may include a short-range wireless communication unit 482 and a wireless communication unit 484.

The short-range wireless communication unit 482 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 484 may include, for example, a cellular network communicator, an Internet communicator, a computer network (e.g., a local area network (LAN) or a wide-area network (WAN) communicator, or the like. However, embodiments are not limited thereto. The wireless communication unit 484 may use subscriber information (e.g., international mobile subscriber identity (IMSI) to identify and authenticate the aerosol generating device 400 in a communication network.

The controller 410 may control the overall operation of the aerosol generating device 400. In an embodiment, the controller 410 may include at least one processor. The at least one processor may be implemented as an array of a plurality of logic gates, or may be implemented as a combination of a general-purpose microprocessor and a memory in which a program executable by the microprocessor is stored. It is to be understood by those having ordinary skill in the art to which the present disclosure pertains that it may be implemented in other types of hardware.

The controller 410 may control the temperature of the heater 450 by controlling the supply of power from the battery 440 to the heater 450. For example, the controller 410 may control the supply of power by controlling the switching of a switching element between the battery 440 and the heater 450. In another example, a direct heating circuit may control the supply of power to the heater 450 according to a control command from the controller 410.

The controller 410 may analyze a sensing result obtained by the sensing of the sensing unit 420 and control processes to be performed thereafter. For example, the controller 410 may control power to be supplied to the heater 450 to start or end an operation of the heater 450 based on the sensing result obtained by the sensing unit 420. As another example, the controller 410 may control an amount of power to be supplied to the heater 450 and a time for which the power is to be supplied, such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when the number of puffs counted through the puff sensor 426 reaches a preset number, the controller 410 may inform the user that the aerosol generating device 400 is to be ended soon, through at least one of the display 432, the haptic portion 434, or the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control the power supply time for an inductive coil to increase a preheating time, compared to a case where the aerosol generating article is in a general state.

An embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. The computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

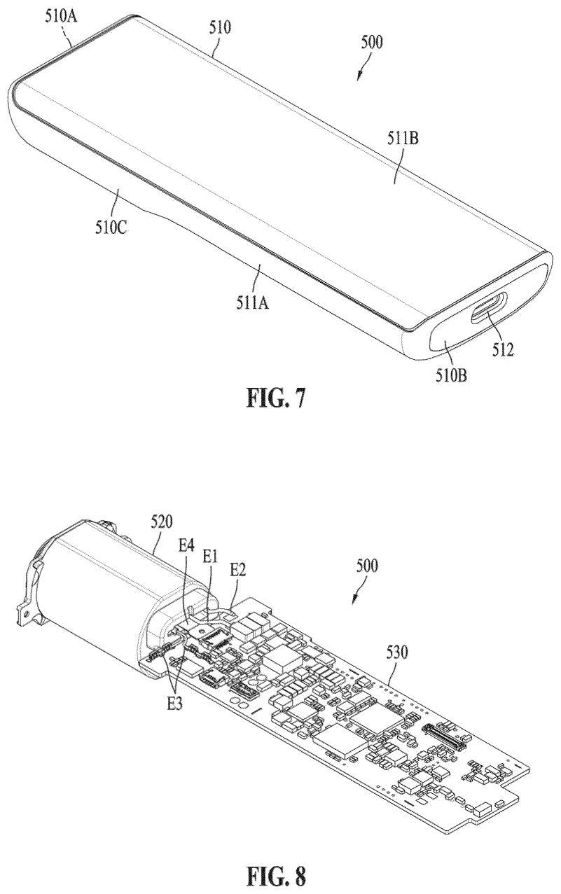

FIG. 7 is a perspective view of an aerosol generating device according to an embodiment.

Referring to FIG. 7, an aerosol generating device 500 may include a housing 510. The housing 510 may include a first housing surface 510A (e.g., a housing front surface), a second housing surface 510B (e.g., a housing rear surface) opposite to the first housing surface 510A, and at least one housing side surface 510C between the first housing surface 510A and the second housing surface 510B.

In an embodiment, the housing 510 may include a plurality of housing parts. For example, the housing 510 may include a first housing part 511A and a second housing pan 511B. The first housing part 511A may substantially form the first housing surface 510A and the second housing surface 510B. The first housing part 511A may form at least a partial area of the housing side surface 510C, and the second housing part 511B may form the remaining area of the housing side surface 510C. In an embodiment, the first housing part 511A may be detachably coupled to the second housing part 511B.

In an embodiment not shown, the housing 510 may include an insertion opening (not shown) configured to allow an aerosol generating article (not shown) to be inserted therein. The insertion opening may be disposed in the first housing surface 510A.

In an embodiment, the housing 510 may include a connecting terminal 512. The connecting terminal 512 may include a connector via which the aerosol generating device 500 may be physically connected to an external electronic device. For example, the connecting terminal 512 may include at least one of a high-definition multimedia interface (HDMI) connector, a universal serial bus (USB) connector, a secure digital (SD) card connector, or an audio connector (e.g., a headphone connector), or a combination thereof.

FIG. 8 is a perspective view of an aerosol generating device including a thermal insulator and a printed circuit board (PCB) according to an embodiment.

Referring to FIG. 8, the aerosol generating device 500 may include a thermal insulator 520. The thermal insulator 520 may be configured to thermally insulate a heater (not shown). The thermal insulator 520 may include a heater (e.g., a coil and/or a susceptor) inside the thermal insulator 520. The thermal insulator 520 may include an antenna (not shown) (e.g., an LCD antenna) inside the thermal insulator 520.

In an embodiment, the aerosol generating device 500 may include a PCB 530. For example, the PCB 530 may include at least one of the controller 410, the sensing unit 420 (e.g., the temperature sensor 422), the memory 470, or the communication unit 480 of FIG. 6, or a combination thereof.

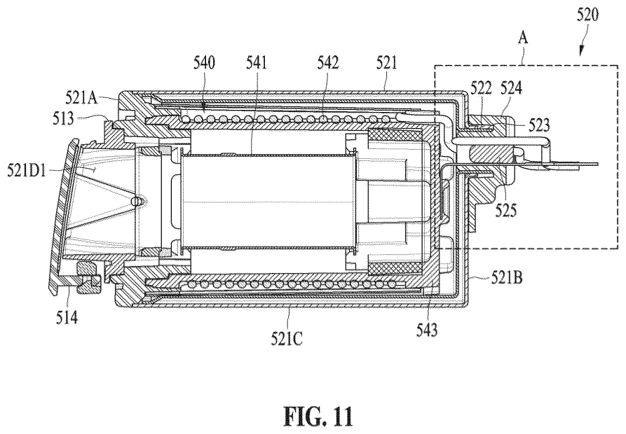

In an embodiment, the aerosol generating device 500 may include a plurality of electrical lines E1, E2, E3, and E4. For example, the first electrical line E1 may be configured to connect the heater (e.g., the heater 450 of FIG. 6) and a temperature sensor (e.g., the temperature sensor 422 of FIG. 6). The second electrical line E2 may be configured to connect the heater (e.g., a coil 542 of a heater 540 of FIG. 11) and the PCB 530. At least one third electrical line E3 may be configured to connect at least one sensor (e.g., the insertion detection sensor 424 of FIG. 6 which may be implemented as an antenna) and the PCB 530. The fourth electrical line E4 may be configured to connect the heater (e.g., a heater housing 543 of the heater 540 of FIG. 11) and the PCB 530. The fourth electrical line E4 may include a flexible printed circuit board (FPCB).

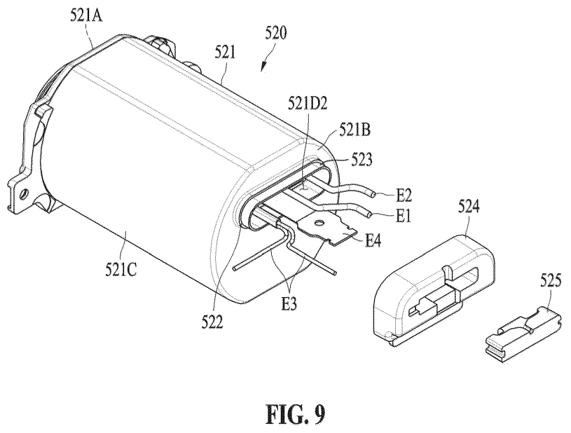

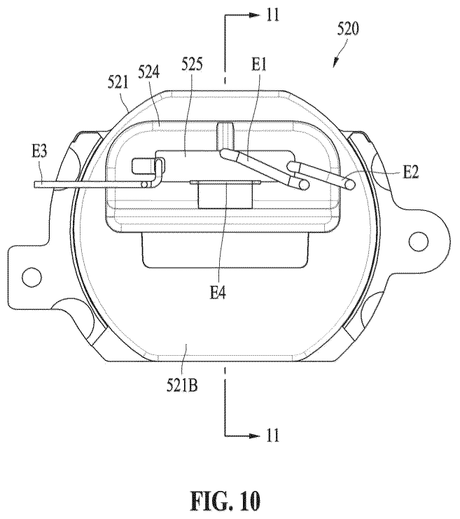

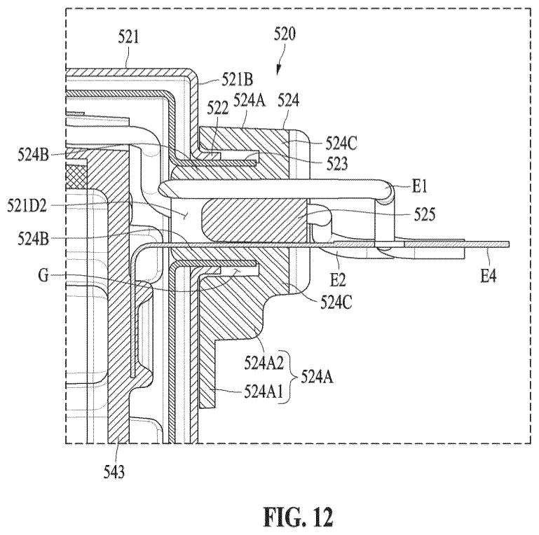

FIG. 9 is an exploded perspective view of a thermal insulator according to an embodiment. FIG. 10 is a front view of a thermal insulator according to an embodiment. FIG. 11 is a cross-sectional view of the thermal insulator of FIG. 10, taken along line 11-11, according to an embodiment. FIG. 12 is an enlarged view of portion A of the thermal insulator of FIG. 11 according to an embodiment.

Referring to FIGS. 9 to 12, the thermal insulator 520 may include a thermally insulating housing 521. The thermally insulating housing 521 may include a first surface 521A (e.g., a front surface), a second surface 521B (e.g., a rear surface) opposite to the first surface 521A, and a side surface 521C between the first surface 521A and the second surface 521B. The first surface 521A, the second surface 521B, and the side surface 521C may surround the heater 540.

In an embodiment, the thermally insulating housing 521 may include a first passage 521D1. The first passage 521D1 may allow an aerosol generating article (not shown) to be inserted into the thermally insulating housing 521. The first passage 521D1 may include a substantially circular or elliptical cross-section.

In an embodiment, an article insertion portion 513 to be included in an aerosol generating device (e.g., the aerosol generating device 500 of FIGS. 7 and 8) may be provided in the first passage 521D1. The article insertion portion 513 may have a size and shape suitable for guiding the aerosol generating article into a susceptor 541 of the heater 540.

In an embodiment, a flap 514 to be included in the aerosol generating device (e.g., the aerosol generating device 500 of FIGS. 7 and 8) may be provided in the first passage 521D1. The flap 514 may be configured to open and close the first passage 521D1. The flap 514 may be configured to open and close the article insertion portion 513. The flap 514 may be configured to operate in a hinged manner.

In an embodiment, the thermally insulating housing 521 may include a second passage 521D2. The second passage 521D2 may allow the plurality of electrical lines E1, E2, E3, and E4 to pass therethrough. The second passage 521D2 may have an elongated shape. The second passage 521D2 may be disposed on the second surface 521B of the thermally insulating housing 521.

In an embodiment, the thermal insulator 520 may include a first flange 522. The first flange 522 may protrude from the second surface 521B. For example, the first flange 522 may protrude in a direction from the first surface 521A toward the second surface 521B. The first flange 522 may be integrally and seamlessly connected to the thermally insulating housing 521. The first flange 522 may include the second passage 521D2 defined at least partially inside the first flange 522.

In an embodiment, the thermal insulator 520 may include a second flange 523. The second flange 523 may surround the plurality of electrical lines E1, E2, E3, and E4. The second flange 523 may be disposed on an inner side of the first flange 522. At least a portion of the second flange 523 may extend between the first surface 521A and the second surface 521B along an inner side surface of the thermally insulating housing 521. At least a portion of the second flange 523 may extend along an inner surface opposite to the second surface 521B of the thermally insulating housing 521. At least a portion of the second flange 523 may be disposed in the second passage 521D2.

In an embodiment, the second flange 523 may extend beyond the first flange 522. The distance between an end portion of the second flange 523 and the second surface 521B may be greater than the distance between an end portion of the first flange 522 and the second surface 521B.

In an embodiment, the thermal insulator 520 may include a first seal 524 (e.g., an outer seal). The first seal 524 may be disposed to surround the first flange 522. The first seal 524 may be disposed to surround at least a portion of the second flange 523.

In an embodiment, the first seal 524 may include an outer enclosure 524A. The outer enclosure 524A may surround the outer side of the first flange 522 and/or the outer side of the second flange 523. The outer enclosure 524A may be disposed on or above the second surface 521B. In other words, the outer enclosure 524A may or may not be in contact with the second surface 521B.

In an embodiment, the outer enclosure 524A may extend in a direction from the first surface 521A toward the second surface 521B. The outer enclosure 524A may extend beyond the end portion of the first flange 522 and/or the end portion of the second flange 523.

In an embodiment, the outer enclosure 524A may include a first base 524A1. The first base 524A1 may be disposed on or above the second surface 521B. The first base 524A1 may extend or expand in a direction away from the outer side of the first flange 522 and/or the outer side of the second flange 523.

In an embodiment, the outer enclosure 524A may include a second base 524A2. The second base 524A2 may be disposed on the first base 524A1. The second base 524A2 may extend or expand in a direction away from the outer side of the first flange 522 and/or the outer side of the second flange 523.

In an embodiment, the width of the second base 524A2 may be greater than the width of the first base 524A1. The first base 524A1 and the second base 524A2 may form a stepped shape.

In an embodiment, the first base 524A1 and the second base 524A2 may be integrally and seamlessly connected to each other.

In an embodiment, the first seal 524 may include an inner enclosure 524B. The inner enclosure 524B may be surrounded by the inner side of the first flange 522 and/or the inner side of the second flange 523. The inner enclosure 524B may contact the second flange 523 at least partially. The inner enclosure 524B may be configured to deform at least in part by the second flange 523. The inner enclosure 524B may remain deformed. The inner enclosure 524B may be disposed at least partially in the second passage 521D2.

In an embodiment, the inner enclosure 524B may extend in a direction from the first surface 521A toward the second surface 521B. The inner enclosure 524B may extend beyond the end portion of the first flange 522 and/or the end portion of the second flange 523. The extending length of the inner enclosure 524B may be greater than the extending length of the outer enclosure 524A.

In an embodiment, the distance between the end surface of the inner enclosure 524B and the second surface 521B may be substantially the same as the distance between the end surface of the outer enclosure 524A and the second surface 521B.

In an embodiment, the outer enclosure 524A and the inner enclosure 524B may form a gap G. The first flange 522 may be disposed in the gap G. At least a portion of the second flange 523 may be disposed in the gap G.

In an embodiment, the first seal 524 may include a connecting enclosure 524C. The connecting enclosure 524C may be configured to connect the outer enclosure 524A and the inner enclosure 524B. The connecting enclosure 524C may cover the end portion of the first flange 522 and/or the end portion of the second flange 523. The connecting enclosure 524C may extend or expand in a direction intersecting with (e.g., orthogonal to) the extending direction of the outer enclosure 524A and/or the extending direction of the inner enclosure 524B.

In an embodiment, the outer enclosure 524A, the inner enclosure 524B, and the connecting enclosure 524C may be integrally and seamlessly connected to each other.

In an embodiment, the first seal 524 may include an elastic material. For example, the first seal 524 may include rubber.

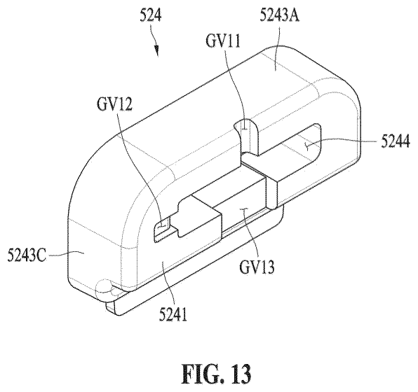

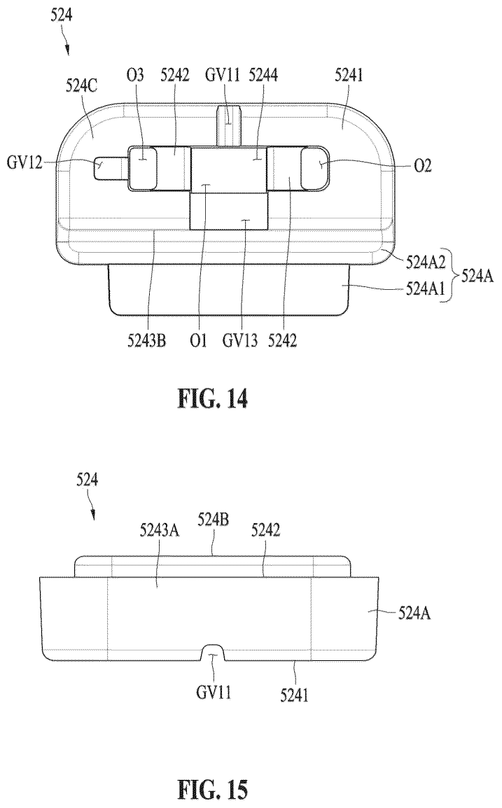

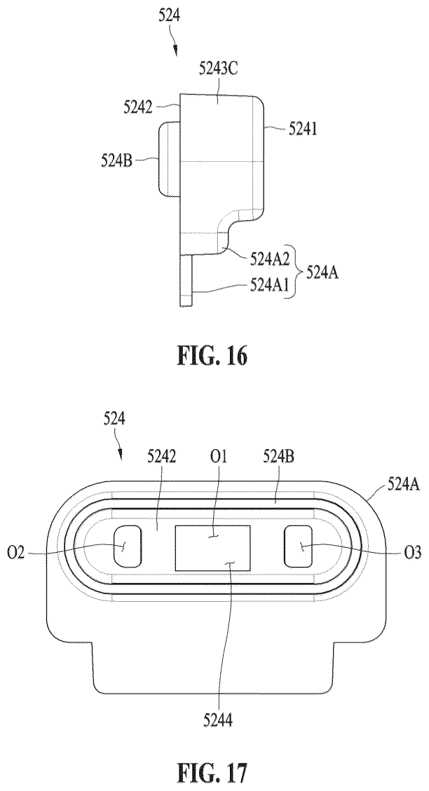

FIG. 13 is a perspective view of a first seal according to an embodiment. FIG. 14 is a front view of the first seal according to an embodiment. FIG. 15 is a plan view of the first seal according to an embodiment. FIG. 16 is a side view of the first seal according to an embodiment. FIG. 17 is a rear view of the first seal according to an embodiment.

Referring to FIGS. 9 to 17, the first seal 524 may include a first scaling front surface 5241, a first sealing rear surface 5242 opposite to the first sealing front surface 5241, and a plurality of first sealing side surfaces 5243A, 5243B, and 5243C between the first sealing front surface 5241 and the first sealing rear surface 5242.

In an embodiment, the outer enclosure 524A may be defined by the plurality of first sealing side surfaces 5243A, 5243B, and 5243C and the first sealing rear surface 5242. The second base 524A2 may extend or expand from the first sealing side surface 5243B. The first base 524A1 may extend or expand from the side surface of the second base 524A2. The inner enclosure 524B may protrude from the second sealing rear surface 5242 in a direction from the first scaling front surface 5241 toward the second sealing rear surface 5242. The connecting enclosure 524C may be defined by the first sealing front surface 5241.

In an embodiment, the first seal 524 may include a first opening 5244. The first opening 5244 may penetrate through the first sealing front surface 5241 and the first sealing rear surface 5242. The first opening 5244 may be formed between the first sealing front surface 5241 and the first sealing rear surface 5242.

In an embodiment, at least a portion of the inner side surface of the first opening 5244 of the first seal 524 may contact at least one of the plurality of electrical lines E1, E2, E3, and E4.

In an embodiment, the first opening 5244 may include a first through opening O1. The first through opening O1 may allow the first electrical line E1 and the fourth electrical line E4 to pass therethrough. The first electrical line E1 may pass through a first side (e.g. the upper side in FIG. 14) of the first through opening O1. The fourth electrical line E4 may pass through a second side (e.g., the lower side in FIG. 14) of the first through opening O1. The first through opening O1 may be disposed substantially at the central portion of the first opening 5244.

In an embodiment, the first opening 5244 may include a second through opening O2. The second through opening O2 may allow the second electrical line E2 to pass therethrough. The second through opening O2 may be disposed on one side (e.g., the right side in FIG. 14) of the first opening 5244. The second through opening O2 may be spaced apart from the first through opening O1. The first through opening O1 and the second through opening O2 may be separated by at least a partial area of the first sealing rear surface 5242.

In an embodiment, the first opening 5244 may include a third through opening O3. The third through opening O3 may allow the third electrical line E3 to pass therethrough. The third through opening O3 may be disposed on the other side (e.g., the left side in FIG. 14) of the first opening 5244 opposite to the second through opening O2 based on the first through opening O1. The third through opening O3 may be spaced apart from the first through opening O1. The first through opening O1 and the third through opening O3 may be separated by at least a partial area of the first sealing rear surface 5242.

In an embodiment, the first seal 524 may include a first groove GV11. The first groove GV11 may be formed on the first sealing front surface 5241 in a direction from the first sealing front surface 5241 toward the first sealing rear surface 5242. The first groove GV11 may extend between the first opening 3244 and the first scaling side surface 5243A. The first groove GV11 may be connected to the first opening 5244. The first groove GV11 may lead to the first sealing side surface 5243A.

In an embodiment, the first seal 524 may include a second groove GV12. The second groove GV12 may be formed on the first sealing front surface 5241 in a direction from the first sealing front surface 5241 toward the first sealing rear surface 5242. The second groove GV12 may extend in a direction (e.g., the leftward direction in FIG. 14) intersecting with (e.g., orthogonal to) the extending direction of the first groove GV11. The second groove GV12 may be connected to the first opening 5244. The second groove GV12 may not lead to the first sealing side surface 5243C.

In an embodiment, the first seal 524 may include a third groove GV13. The third groove GV13 may be formed on the first sealing front surface 5241 in a direction from the first sealing front surface 5241 toward the first sealing rear surface 5242. The third groove GV13 may extend in a direction (e.g., the downward direction in FIG. 14) opposite to the extending direction of the first groove GV11. The third groove GV13 may be connected to the first opening 5244. The third groove GV13 may lead to the first scaling side surface S243B.

Referring to FIGS. 9 to 12 again, the thermal insulator 520 may include a second seal 525 (e.g., an inner seal). The second seal 525 may be configured to seal a space between the plurality of electrical lines E1, E2, E3, and E4 and the first seal 524.

In an embodiment, the second seal 525 may be disposed at least partially in the second passage 521D2. The second seal 525 may include a surface (e.g., the second scaling front surface 5251) that is substantially on the same plane as one surface (e.g., the first sealing front surface 5241) of the first seal 524.

In an embodiment, the second seal 525 may overlap the first seal 524 and the plurality of electrical lines E1, E2, E3, and E4. For example, the second seal 525 may be disposed in the first opening 5244 of the first seal 524. At least a portion of the second seal 525 may closely contact the first seal 524 and the plurality of electrical lines E1, E2, E3, and E4.

In an embodiment, the second seal 525 may be a separate component that is separated from the first seal 524.

In an embodiment, the second seal 525 may include an elastic material. For example, the second seal 525 may include rubber.

In an embodiment, the material of the first seal 524 may be the same as the material of the second seal 525. In an embodiment, the material of the first seal 524 may be different from the material of the second seal 525.

According to an embodiment, the first seal 524 and the second seal 525 may be configured to thermally insulate the second passage 521D2 by sealing the second passage 521D2. According to an embodiment, the first seal 524 and the second seal 525 may reduce or block a material (e.g., a droplet) that may flow from the inside of the thermally insulating housing 521 through the second passage 521D2 to the outside of the thermally insulating housing 521.

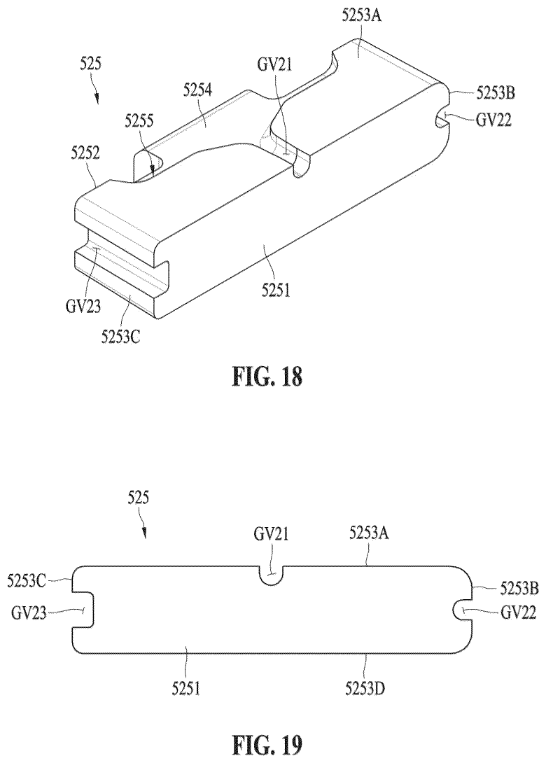

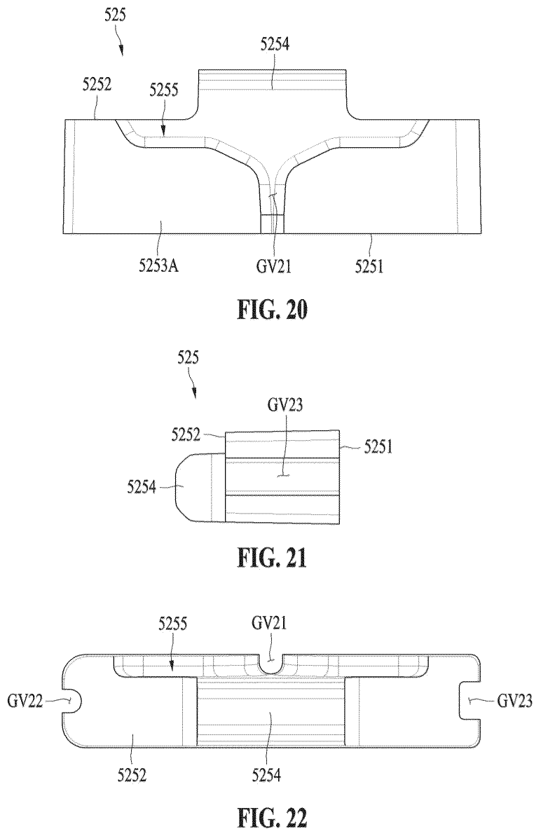

FIG. 18 is a perspective view of a second seal according to an embodiment. FIG. 19 is a front view of the second seal according to an embodiment. FIG. 20 is a plan view of the second seal according to an embodiment. FIG. 21 is a side view of the second seal according to an embodiment. FIG. 22 is a rear view of the second seal according to an embodiment.

Referring to FIGS. 18 to 22, the second seal 525 may include a second sealing front surface 5251, a second sealing rear surface 5252 opposite to the second sealing front surface 5251, and a plurality of second sealing side surfaces 5253A, 52538, 5253C, and 5253D between the second sealing front surface 5251 and the second sealing rear surface 5252.

In an embodiment, the plurality of second sealing side surfaces 5253A, 5253B, 5253C, and 5253D may contact an inner side surface of the first opening 5244 of the first seal 524 of FIGS. 13 to 17 at least partially. The second scaling side surface 5253D of the second seal 525 may contact a fourth electrical line (e.g., the fourth electrical line E4 of FIG. 10).

In an embodiment, the second seal 525 may include a fourth groove GV21. The fourth groove GV21 may be configured to receive a first electrical line (e.g., the first electrical line E1 of FIG. 10) at least partially. The fourth groove GV21 may be formed on the second sealing side surface 5253A in a direction from any one second sealing side surface 5253A toward the second sealing side surface 5253D opposite thereto. The fourth groove GV21 may extend between the second sealing front surface 5251 and the second sealing rear surface 5252. The fourth groove GV21 may lead to each of the second sealing front surface 5251 and the second sealing rear surface 5252. The fourth groove GV21 may extend in parallel to the second sealing side surfaces 5253B and 5253C.

In an embodiment, the second seal 525 may include a fifth groove GV22. The fifth groove GV22 may be configured to receive a second electrical line (e.g., the second electrical line E2 of FIG. 10) at least partially. The fifth groove GV22 may be formed on the second sealing side surface 5253B. The fifth groove GV22 may extend between the second sealing front surface 5251 and the second sealing rear surface 5252. The fifth groove GV22 may lead to each of the second sealing front surface 5251 and the second sealing rear surface 5252.

In an embodiment, the second seal 525 may include a sixth groove GV23. The sixth groove GV23 may be configured to receive a third electrical line (e.g., the third electrical line E3 of FIG. 10) at least partially. The sixth groove GV23 may be formed on the second sealing side surface 5253C opposite to the second sealing side surface 5253B. The sixth groove GV23 may extend between the second sealing front surface 5251 and the second scaling rear surface 5252. The sixth groove GV23 may lead to each of the second sealing front surface 5251 and the second sealing rear surface 5252.

In an embodiment, the second seal 525 may include a protruding portion 5254. The protruding portion 5254 may protrude from the second sealing rear surface 5252. The protruding portion 5254 may be disposed at least partially in the first through opening O1 of the first seal 524 of FIGS. 13 to 17. The protruding portion 5254 may be disposed at least partially in the second passage 521D2 of FIG. 12.

In an embodiment, the second seal 525 may include a recessed portion 5255. The recessed portion 5255 may be disposed on the second sealing rear surface 5252. The recessed portion 5255 may be disposed on the second sealing side surface 5253A. The recessed portion 5255 may include a curved surface at least partially. The recessed portion 5255 may face the first sealing rear surface 5242 of the first seal 524 of FIGS. 13 to 17. The recessed portion 5255 may contact the first sealing rear surface 5242 at least partially. The areas of the second sealing rear surface 5252 excluding the recessed portion 5255 may be disposed at least partially in the second through opening O2 and/or the third through opening O3 of the first seal 524.

The features and aspects of any embodiment(s) described above may be combined with features and aspects of any other embodiment(s) without resulting in apparent technical conflicts.

1. An aerosol generating device comprising:
a heater;
a printed circuit board (PCB);
an electrical line configured to connect the heater and the PCB; and
a thermal insulator comprising:
a thermally insulating housing comprising a first surface, a second surface opposite to the first surface, and a side surface between the first surface and the second surface to surround the heater;
a flange protruding from the second surface;
a passage through which the electrical line passes, wherein the passage is defined in the flange;
a first seal surrounding the flange; and
a second seal overlapping the first seal and the electrical line.

2. The aerosol generating device of claim 1, wherein the first seal comprises:
an outer enclosure disposed on an outer side of the flange;
an inner enclosure disposed on an inner side of the flange and in the passage; and
a connecting enclosure connecting the outer enclosure and the inner enclosure.

3. The aerosol generating device of claim 1, wherein the first seal comprises:
a first base disposed on the second surface; and
a second base disposed on the first base,
wherein a width of the first base is greater than a width of the second base in a direction away from the flange.

4. The aerosol generating device of claim 1, wherein
the second seal comprises a groove configured to receive the electrical line at least partially.

5. The aerosol generating device of claim 1, wherein
the first seal comprises an opening through which the electrical line passes, and
the second seal is disposed at least partially in the opening.

6. The aerosol generating device of claim 1, wherein
the first seal and the second seal are separable from each other.

7. The aerosol generating device of claim 1, wherein
the first seal and the second seal each comprise an elastic material.

8. The aerosol generating device of claim 1, wherein
the flange protrudes from the second surface in a direction from the first surface toward the second surface.

9. The aerosol generating device of claim 1, further comprising:
a temperature sensor configured to detect a temperature of the heater; and
an additional electrical line configured to connect the temperature sensor and the PCB.

10. The aerosol generating device of claim 1, further comprising:
an insertion detection sensor configured to detect an aerosol generating article; and
an additional electrical line configured to connect the insertion detection sensor and the PCB.

11. A thermal insulator comprising:
a thermally insulating housing comprising a first surface, a second surface opposite to the first surface, and a side surface between the first surface and the second surface;
a flange protruding from the second surface;
a passage defined in the flange;
a first seal surrounding the flange; and
a second seal overlapping the first seal.

12. The thermal insulator of claim 11, wherein the first seal comprises:
an outer enclosure disposed on an outer side of the flange;
an inner enclosure disposed on an inner side of the flange and in the passage; and
a connecting enclosure connecting the outer enclosure and the inner enclosure.

13. The thermal insulator of claim 11, wherein the first seal comprises:
a first base disposed on the second surface; and
a second base disposed on the first base,
wherein a width of the first base is greater than a width of the second base in a direction away from the flange.

14. The thermal insulator of claim 11, wherein
the second seal comprises a groove.

15. The thermal insulator of claim 11, wherein
the first seal comprises an opening, and
the second seal is disposed at least partially in the opening.
